(19) United States
(12) Patent Application Publication
(10) Pub. No.: US 2005/0144429 A1
(43) Pub. Date: Jun. 30, 2005

(54) System for customizing a computer system

(75) Inventor: David B. Rhoades, Raleigh, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/748,937

(22) Filed: Dec. 30, 2003

(51) Int. Cl. G06F 15/177

(52) U.S. Cl. 713/1

(57) ABSTRACT

The present invention is related to a method and system for customizing a computer system. According to a preferred embodiment, the method includes storing customization information for the computer system in a configuration mechanism and coupling the configuration mechanism to the computer system. The customization information in the configuration mechanism is then retrieved by the computer system to customize the computer system.

### FIELD OF THE INVENTION

The present invention relates to computer systems and more particularly to a method and system for customizing a computer system.

### BACKGROUND OF THE INVENTION

Typically, a computer system is provided with a preconfigured operating system (OS), which is then customized or configured for a specific user. The configuration of the OS generally involves assigning configuration parameters, such as a computer name, host name, host IP address, host gateway, host subnet, etc., to the computer system, and can be performed by a reseller or dealer, on site via an automated process, or on site by the specific user.

If performed by the reseller or dealer, the computer system's final destination must be known prior to the configuration process. For large computer system rollouts, the dealer will typically store a large quantity of computer systems and customize them as they are deployed to various destinations. If these computer systems are not shipped immediately to their respective destinations, but warehoused instead, the dealer must be able to identify a particular computer system, e.g., by serial number, for a particular destination at shipping time. Physically identifying the particular computer system among thousands of warehoused computer systems can be a daunting task. If the computer system is shipped to an incorrect destination, the configuration parameters embedded in the computer system's OS will not correspond to the destination, and the computer system will not operate correctly.

At the user's site, the system configuration can be deployed via an automated process, e.g., by transmitting the customized OS over a network link. Nevertheless, this process requires network bandwidth and if the customized OS is large, e.g., 10-15 gigabytes, the transmission can take hours. Alternatively, the OS can be customized manually by the user, which introduces data entry errors. Nevertheless, for complex program images, it may be necessary to incur the expense of hiring a skilled configuration expert to handle the customization.

Accordingly, there exists a need for a method and system for customizing a computer system. The method and system should allow the computer system to be configured quickly at the dealer or on site, and should have little or no impact on network bandwidth. The present invention addresses such a need.

### SUMMARY OF THE INVENTION

The present invention is directed to a method and system for customizing a computer system. According to a preferred embodiment, the method includes storing customization information for the computer system in a configuration mechanism and coupling the configuration mechanism to the computer system. The customization information in the configuration mechanism is then retrieved by the computer system to customize the computer system.

Through aspects of the preferred embodiment of the present invention, the configuration mechanism and the computer system are shipped separately but in the same shipment to a customer site. The configuration mechanism is then coupled to the computer system at the customer site. During a first system boot, the computer system queries the configuration mechanism to retrieve the customization information.

### BRIEF DESCRIPTION OF THE DRAWINGS

FIG. 1 is a block diagram depicting a computer system 10 according to a preferred embodiment of the present invention.

FIG. 2 is a flowchart illustrating a process for configuring the server 10 according to a preferred embodiment of the present invention.

### DETAILED DESCRIPTION

The present invention relates to computer systems and more particularly to a method and system for customizing a computer system. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

According to the preferred embodiment of the present invention, configuration parameters that are utilized to customize a computer system's OS are stored in a configuration mechanism. The configuration mechanism preferably is a PCI adapter that includes at least one communication port. When coupled to the computer system, the configuration mechanism provides the necessary information to customize the computer system.

Through aspects of the preferred embodiment of the present invention, a generic computer system is shipped to a destination, e.g., a remote branch office, along with a configuration mechanism that includes configuration parameters for the remote branch. At the remote branch, the configuration mechanism is coupled, e.g., plugged in, to the computer system. During a first system boot, the computer system automatically customizes its OS via the configuration mechanism.

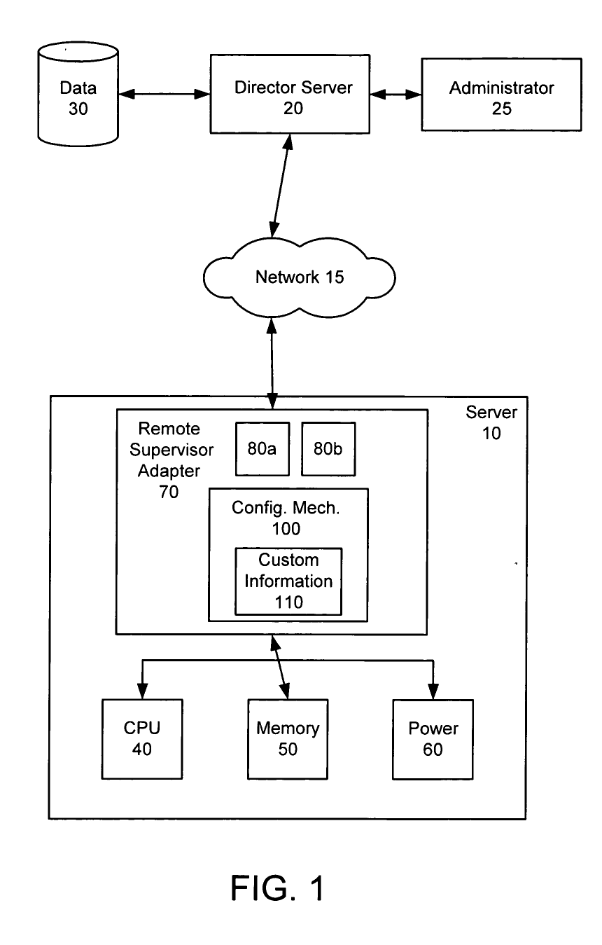

To describe the preferred embodiment of the present invention in more detail, please refer now to FIG. 1, which is a block diagram depicting a computer system 10 according to a preferred embodiment of the present invention. The computer system 10 preferably is a server 10, such as an xSeries™ server developed by International Business Machines of Armonk, N.Y. As is shown, the server 10 includes standard components, such as a CPU 40, memory 50, and a power source or adapter 60. Those skilled in the art readily appreciate that the server 10 includes other standard components and devices that are not illustrated in FIG. 1. The server 10 also includes a remote supervisor adapter (RSA) 70, which allows a system administrator 25 to manage the server 10 remotely, e.g., via an out-of-band network interface (not shown), or in another embodiment, via a built-in web interface on the RSA 70 (not shown).

The RSA 70 provides continuous remote access to the server 10 regardless of the on or off status of the server 10. In addition, the RSA 70 continuously monitors critical system components for potential problems and alerts the administrator 25 of events that can impact the system operation. The RSA 70 is a PCI adapter that includes a serial port 80a for supporting system management functions through a modem, an Ethernet port 80b for enabling system management functions over a LAN connection, and a power connector and AC adapter (not shown). Through the Ethernet port 80b, the RSA 70 can be connected directly to a data network or to a dedicated management LAN 15. The system management functions of the RSA 70 can be exploited at any time or anywhere from the LAN 15, even if the server 10 has failed or is powered off. Moreover, LAN throughput allows for increased performance and additional functions.

According to a preferred embodiment of the present invention, the RSA 70 includes a configuration mechanism 100. The configuration mechanism 100 stores customization information 10, including configuration parameters, that are used to personalize the server 10. Such configuration parameters include IP address information, computer name, host name and other personalized information. While FIG. 1 shows the configuration mechanism 100 integrated in the RSA 70, those skilled in the art would appreciate that the configuration mechanism 100 can also be a stand alone module coupled to a PCI adapter, such as the RSA 70.

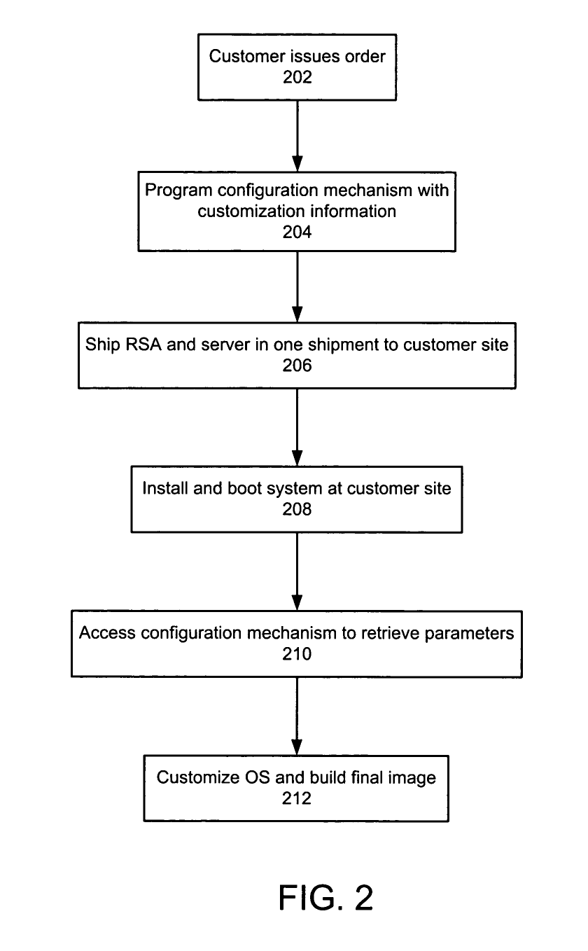

To describe how the configuration mechanism 100 is utilized to customize the server 10, please refer now to FIG. 2, which is a flowchart illustrating a process for customizing the server 10 according to a preferred embodiment of the present invention. The process begins at step 202 when a customer orders one or more servers 10 from a dealer. Presumably, the dealer has warehoused multiple servers that have been built with a specified configuration with the exception of the customized configuration parameters. The order typically includes all the information necessary to customize the server. In step 204, the dealer takes an RSA 70 and programs a configuration mechanism 100 therein to include the customization information 110, including configuration parameters, derived from the order. This programming process can be performed quickly via the Ethernet port 80b in the RSA 70.

Once programmed, the RSA 70 and the server 10 are shipped separately but in the same shipment to the customer site in step 206. Accordingly, the server 10 is not removed from its packaging. There, the customer installs the RSA 70 into the server 10, turns the server on, and initiates a booting process in step 208. During the first system boot, the server 10 queries the RSA 70, accesses the configuration mechanism 100 and retrieves the customization information 110, including the configuration parameters via step 210. In a preferred embodiment, the customization information 110 is embedded into corresponding sections of a SysPrep.INF file, which is utilized during a SysPrep process. It is noted that while SysPrep is the application/supported process for MicroSoft operating systems, the customization information 110 can also be embedded in equivalent portions of applications and processes used for other well known operating systems. The configuration parameters 110 are then used to customize the OS and to build the final system image in step 212. In a preferred embodiment, the customizing step can be performed by booting first into a DOS partition that calls the RSA 70 and performs the personalization prior to loading the OS.

While the above process describes a dealer programming the configuration mechanism 100, those skilled in the art will recognize that other parties can also perform the programming step as well. For instance, a manufacturer or even a third party shipping company can offer this service to its customers. Moreover, the configuration mechanism 100 can also be programmed quickly by downloading the customization information 110 from a Director server 20 (FIG. 1) to the RSA 70 via the Ethernet port 80b.

Through aspects of the preferred embodiment of the present invention, a computer system can be automatically customized at a customer site during the first system boot. By programming the configuration mechanism(s) 100 at the time an order is fulfilled and shipping the programmed configuration mechanism(s) 100 along with the generic server(s) 10, the dealer, manufacturer, or shipping company need not be concerned with shipping a warehoused system that has been preconfigured to the incorrect address.

Although the present invention has been described in accordance with the embodiment shown, one of ordinary skill in the art will readily recognize that there could be variations to the embodiment and those variations would be within the spirit and scope of the present invention. For example, the configuration mechanism can be implemented as a stand alone PCI adapter and does not necessarily require an RSA. Accordingly, many modifications may be made by one of ordinary skill in the art without departing from the spirit and scope of the appended claims.

1. A system for customizing a computer system comprising:
a configuration mechanism for storing customization information for the computer system, wherein when the configuration mechanism is coupled to the computer system, the computer system is configured to retrieve during a first system boot the customization information in the configuration mechanism to customize the computer system.

2. The system of claim 1 wherein the configuration mechanism is a PCI adapter that is configured to plug into the computer system.

3. The system of claim 2 wherein the configuration mechanism is manually programmed with the customization information at a distribution site.

4. The system of claim 2 wherein the configuration mechanism includes at least one communication port.

5. The system of claim 4 wherein the customization information is download from a server to the configuration mechanism via the at least one communication port.

6. The system of claim 2, wherein the computer system and the configuration mechanism are shipped separately but in the same shipment to a customer site prior to coupling the configuration mechanism to the computer system.
